(19) United States
(12) Patent Application Publication
(10) Pub. No.: US 2003/0027035 A1
(43) Pub. Date: Feb. 6, 2003

(54) PEM fuel cell and process for producing an anode for such a PEM fuel cell

(76) Inventors: Armin Datz, Poxdorf (DE); Konrad Mund, Uttenreuth (DE)

Correspondence Address: LERNER AND GREENBERG, PA, Post Office Box 2480, Hollywood, FL, 33022-2480, US

(21) Appl. No.: 10/105,549

(22) Filed: Mar. 25, 2002

Related U.S. Application Data
(63) Continuation of application No. PCT/DE00/03169, filed on Sep. 12, 2000.

(30) Foreign Application Priority Data
Sep. 23, 1999 (DE) 199 45 712.3

(51) Int. Cl. H01M 4/86; H01M 8/10; H01M 4/96; H01M 4/88

(52) U.S. Cl. 429/44; 429/32; 502/101

(57) ABSTRACT

The PEM fuel cell has a membrane-electrode assembly with an anode and a cathode and associated bipolar plates. The anode, which forms a hydrogen electrode of the PEM fuel cell, is formed with a substrate of a metal and/or an alloy that is corrosion-resistant within the operational potential range of the hydrogen electrode. That is, the substrate is a good electrical conductor, instead of the poorly conducting carbon powder, and the flow of current within the cell is improved. A catalyst, which is active for the oxidation, is provided at least on the surface of the anode substrate.

### CROSS-REFERENCE TO RELATED APPLICATION

This application is a continuation of copending International Application No. PCT/DE00/03169, filed Sep. 12, 2000, which designated the United States.

### BACKGROUND OF THE INVENTION

Field of the Invention

The invention lies in the fuel cell technology field. More specifically, the invention relates to a PEM fuel cell comprising a membrane-electrode assembly with an anode and a cathode and associated bipolar plates. The anode comprises an active catalyst layer with a substrate made from a metal and/or an alloy, and the catalyst layer, which is active for the oxidation, is situated at least on the surface of the substrate. The invention also relates to a process for producing an anode for a PEM fuel cell of this type.

In PEM (polymer electrolyte membrane) fuel cells, chemical energy is converted into electrical energy. In the process hydrogen and oxygen are converted into water. At the anode, hydrogen is oxidized to form individual hydrogen ions (protons), which migrate through the electrolyte and at the cathode meet oxygen ions, with which they combine to form water.

The electrolyte used is, for example, a membrane or matrix which contains an acid. For anodic oxidation, a catalyst, such as platinum, is used at the anode. In prior art systems (cf. K. Ledjeff: Brennstoffzellen—ein Überblick [Fuel Cells—An Overview] (p. 26) in K. Ledjeff “Brennstoffzellen” [Fuel Cells], Müller Verlag, Heidelberg 1995), the catalyst is preferably applied to carbon powder, which forms the substrate. According to U.S. Pat. No. 4,215,183 (German patent DE 29 51 965 C2), a carbon paper, which has been preferably been rendered hydrophobic, is pressed between the catalyst layer and the bipolar plate, which carries the current to and from the cell, as current collector, in order to optimally collect and conduct the current to the electrode. Nevertheless, there are still considerable losses of current during the collection and conduction of the current, which have an adverse effect on the overall efficiency of the fuel cell.

The commonly assigned international published PCT application WO 97/50141 A1 describes an anode for a direct methanol fuel cell (DMFC). There, means are provided which keep the particles of the anode catalyst in electrolytic and electronic contact, in such a way that electrolytic and electronic current transfer within the anode is ensured and the methanol provided is virtually completed oxidized in the anode. The result is a diffusion gradient for methanol within the anode, with a low methanol concentration at the anode/membrane phase boundary. As a result, in that location, for the methanol-flushed anode, there are substrate materials comprising precious metals, and active catalysts, such as platinum, ruthenium and Pt/Ru alloys, and also molybdenum, titanium, rhenium, tin and alloys of these components.

In principle, different boundary conditions apply to PEM fuel cells with hydrogen-flushed anodes.

### SUMMARY OF THE INVENTION

It is accordingly an object of the invention to provide a PEM fuel cell and a fabrication method, which overcomes the above-mentioned disadvantages of the heretofore-known devices and methods of this general type and which provides for a suitable anode in a PEM fuel cell wherein the current conduction is improved.

With the foregoing and other objects in view there is provided, in accordance with the invention, a PEM fuel cell, comprising:

a membrane-electrode assembly with an anode and a cathode and associated bipolar plates;

the anode having a substrate of a material selected from the group consisting of a metal and an alloy, and having a surface carrying a catalyst layer with a catalyst active for an oxidation in the fuel cell;

wherein the anode is a hydrogen-flushed electrode of the fuel cell; and

the substrate is resistant to corrosion within a potential interval of the hydrogen-flushed electrode.

In accordance with an added feature of the invention, a carbon paper is disposed between the active catalyst layer and the bipolar plate. In a preferred embodiment, the carbon paper is treated with a hydrophobic polymer.

With the above and other objects in view there is also provided, in accordance with the invention, a method of producing an anode for a PEM fuel cell having a membrane-electrode assembly with an anode and a cathode and associated bipolar plates, wherein the anode forms a hydrogen electrode of the fuel cell operating within a defined potential interval. The method comprises the steps of providing a substrate that is resistant to corrosion within the potential interval of the hydrogen electrode, and applying a material for an active catalyst layer to the substrate.

In the invention, an anode for a fuel cell includes an active catalyst layer, wherein a substrate, which consists of a metal and/or an alloy which are resistant to corrosion within the potential interval of the hydrogen electrode is present for the active catalyst layer, the catalyst which is active for the oxidation being situated on the surface of this substrate.

In the process according to the invention for the production of an anode for a fuel cell, active catalyst material is applied to a substrate, which is resistant to corrosion within the potential interval of the hydrogen electrode.

The invention advantageously produces a high conductivity of the substrate and a low bulk resistance of the active catalyst and/or substrate layer, which result in a considerable improvement to the conduction of current from the anode to the bipolar plate. The term potential interval of the hydrogen electrode is understood as meaning the part of an electrode which has a polarization of less than 100 mV, i.e. in a range 0-100 mV.

Further advantages and details of the invention will emerge from the description of exemplary embodiments, wherein an anode for a fuel cell is formed from an electrically conductive substrate and an active catalyst layer. The catalyst layer is adjoined by a bipolar plate.

The term “active catalyst” refers to catalyst material which, for oxidation or reduction, is applied to one of the electrodes, so that the fuel cell reaction can take place. At the anode, the active catalyst is preferably platinum and/or a platinum-containing alloy with other metals from the precious-metal group, such as ruthenium, rhodium, palladium, osmium and/or iridium.

An anode for a fuel cell comprises an active catalyst layer which directly adjoins the electrolyte and is gas-permeable, a reaction chamber for the anode gas and a current conductor, such as for example a bipolar plate which simultaneously serves to close off the reaction chamber from the environment.

The bipolar plate, which is also known as a terminal plate, delimits a first fuel cell from the subsequent second fuel cell; if there is a multiplicity of fuel cells, what is known in the pertinent art as a fuel cell stack is formed. The bipolar plate is generally also used to carry current to and from the cell.

Depending on the particular embodiment, there may be a carbon paper between the active catalyst layer and the bipolar plate, in order to improve conduction.

In accordance with an added feature of the invention, the substrate consists of silver and/or copper.

Various processes for producing an anode of this type are possible. It is essential for the active catalyst in each case to be electrically conductively connected to the substrate.

In accordance with one embodiment of the production process, the catalyst is deposited on the substrate by electrodeposition.

In accordance with another feature of the invention, the substrate is present in the form of powder which is coated.

In accordance with again another mode of the production process, catalyst is sputtered onto the substrate.

In accordance with again a further feature of the invention, the catalyst is deposited on the substrate using a wet-chemical process.

According to a further embodiment of the production process, the substrate powder is mixed with the catalyst material. In that case, the result after processing—at least in part—is a combined layer of substrate and catalyst. In this case, bonding of the catalyst with the aid of a hydrophobic polymer, such as for example PTFE (Teflon®), may be advantageous.

According to one embodiment of the anode, a hydrophobic polymer, such as for example Teflon, is applied to the substrate to enhance bonding of the catalyst to the substrate.

The invention improves the transfer of current within the fuel cell by replacing the substrate for the catalyst, which hitherto consisted of carbon powder of unsatisfactory electronic conductivity, with metal, which has a good electronic conductivity, at the anode.

We claim:

1. A PEM fuel cell, comprising:
a membrane-electrode assembly with an anode and a cathode and associated bipolar plates;
said anode having a substrate of a material selected from the group consisting of a metal and an alloy, and having a surface carrying a catalyst layer with a catalyst active for an oxidation in the fuel cell;
wherein said anode is a hydrogen-flushed electrode of the fuel cell; and
said substrate is resistant to corrosion within a potential interval of said hydrogen-flushed electrode.

2. The PEM fuel cell according to claim 1, which comprises a carbon paper disposed between said active catalyst layer and a respective said bipolar plate.

3. The PEM fuel cell according to claim 2, wherein said carbon paper is treated with a hydrophobic polymer.

4. The PEM fuel cell according to claim 1, wherein said substrate is in powder form.

5. The PEM fuel cell according to claim 1, wherein said substrate consists of at least one metal selected from the group consisting of silver and copper.

6. A method of producing an anode for a PEM fuel cell having a membrane-electrode assembly with an anode and a cathode and associated bipolar plates, wherein the anode forms a hydrogen electrode of the fuel cell operating within a defined potential interval, the method which comprises providing a substrate that is resistant to corrosion within the potential interval of the hydrogen electrode, and applying a material for an active catalyst layer to the substrate.

7. The process according to claim 6, wherein the applying step comprises applying the catalyst material on the substrate by electrodeposition.

8. The process according to claim 6, wherein the applying step comprises sputtering the catalyst material onto the substrate.

9. The process according to claim 6, wherein the applying step comprises wet-chemically depositing the catalyst material on the substrate.

10. The process according to claim 6, which comprises at least partially mixing the catalyst material with substrate material of the substrate.
